(19) United States
(12) Patent Application Publication
(10) Pub. No.: US 2016/0202576 A1
(43) Pub. Date: Jul. 14, 2016

(54) LIQUID CRYSTAL DISPLAY HAVING IMPROVED APERTURE RATIO

(71) Applicant: SAMSUNG DISPLAY CO., LTD., Yongin-si (KR)

(72) Inventors: Seung-Jin BAEK, Suwon-si (KR); Sang Il KIM, Yongin-si (KR); Myung Hwan PARK, Suwon-si (KR)

(21) Appl. No.: 14/964,449

(22) Filed: Dec. 9, 2015

(30) Foreign Application Priority Data
Jan. 9, 2015 (KR) 10-2015-0003665

(51) Int. Cl. G02F 1/1343; G02F 1/1335; G02F 1/1339; G02F 1/1333

(52) U.S. Cl. CPC G02F 1/134336; G02F 1/133377; G02F 1/133512; G02F 1/13394; G02F 1/133514

(57) ABSTRACT

A liquid crystal display is provided. The liquid crystal display includes: a substrate including a plurality of pixels; a pixel electrode disposed in each of the pixels; a roof layer facing the pixel electrode; a liquid crystal layer disposed in a plurality of microcavities between the pixel electrodes and the roof layer, each of the microcavities including liquid crystal material therein, wherein each of the microcavities extends across at least two of the pixels, and a width of a first light blocking member positioned between adjacent ones of the pixels corresponding to one microcavity and a width of a second light blocking member positioned between adjacent pixels of adjacent microcavities are different from each other.

### CROSS-REFERENCE TO RELATED APPLICATION

This application claims priority to, and the benefit of, Korean Patent Application No. 10-2015-0003665 filed in the Korean Intellectual Property Office on Jan. 9, 2015, the entire contents of which are incorporated herein by reference.

### BACKGROUND

(a) Field

Embodiments of the present invention relate generally to liquid crystal displays. More specifically, embodiments of the present invention relate to liquid crystal displays having improved aperture ratio.

(b) Description of the Related Art

A liquid crystal display device, which is one common form of flat panel display device, includes two display panels on which electric field generating electrodes such as a pixel electrode, a common electrode, and the like are formed, and a liquid crystal layer interposed between the two display panels.

A voltage is applied to the electric field generating electrode to generate an electric field in the liquid crystal layer, thereby determining alignment of liquid crystal molecules of the liquid crystal layer and controlling polarization of incident light, so as to display an image.

One type of liquid crystal display utilizes a plurality of microcavities within its pixels, where the microcavities contain the liquid crystals for each pixel. Other types of liquid crystal displays use two substrates. In contrast, microcavity-type liquid crystal displays utilize a single substrate to decrease a weight, a thickness, and the like, of the liquid crystal display.

In the display device in which the plurality of microcavities are formed, a partition wall is present in order to partition the plurality of microcavities. An alignment defect may occur in the partition wall, and a width of a light blocking member corresponding to the partition wall may be widened in consideration of this problem. However, when the width of the light blocking member is widened, an aperture ratio may be decreased.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a liquid crystal display having improved aperture ratio.

An exemplary embodiment of the present invention provides a liquid crystal display including: a substrate including a plurality of pixels; a pixel electrode disposed in each of the pixels; a roof layer facing the pixel electrode; a liquid crystal layer disposed in a plurality of microcavities between the pixel electrodes and the roof layer, each of the microcavities including liquid crystal material therein, wherein each of the microcavities extends across at least two of the pixels, and a width of a first light blocking member positioned between adjacent ones of the pixels corresponding to one microcavity and a width of a second light blocking member positioned between adjacent pixels of adjacent microcavities are different from each other.

Each microcavity may extend across three of the pixels so as to form a pixel group, and the liquid crystal display may further include a repeated arrangement of the pixel groups.

The liquid crystal display may further include a partition wall part between adjacent microcavities.

Each pixel group may include a red pixel, a green pixel, and a blue pixel.

The pixels may be arranged in a matrix configuration, the matrix configuration may include adjacent first and second rows, and the pixel groups of the first row may have an order of pixel colors that is different from that of the pixel groups of the second row.

The liquid crystal display may further include a color filter disposed on the substrate, wherein the color filter includes a red color filter, a green color filter, and a blue color filter respectively corresponding to the red pixels, the green pixels, and the blue pixels, and the first light blocking member is disposed between adjacent ones of the color filters corresponding to the pixels of one microcavity, and the second light blocking member is disposed between color filters corresponding to the pixels of adjacent ones of the microcavities.

The partition wall part may overlap the second light blocking member.

The pixels and their corresponding microcavities may be arranged in a matrix configuration having rows of the pixels and rows of the microcavities, and further having columns of the pixels and columns of the microcavities, where the microcavities of each column of the microcavities are offset from one another.

Each column of the pixels may have pixels of only a single color.

The liquid crystal display may further include a data line, wherein the data line includes a first data line positioned between the pixels of one microcavity, and a second data line positioned between adjacent microcavities, where the first data line overlaps the first light blocking member, and the second data line overlaps the second light blocking member.

Microcavities of one column of the microcavities may be offset from each other by one pixel width.

The second light blocking member of one row of the pixels may be offset from the second light blocking member of another row of the pixels.

The order of colors of the pixels of the microcavities of one row of the pixels may be repeated every three rows of the pixels.

The pixels and their corresponding microcavities may be arranged in a matrix configuration having rows of the pixels and rows of the microcavities and further having columns of the pixels and columns of the microcavities, and the microcavities of each column of the microcavities may be substantially collinear.

Different columns of the pixels may have pixels of different colors.

The liquid crystal display may further include a data line, wherein the data line includes a first data line positioned between two pixels of one microcavity, and a second data line positioned between adjacent microcavities, where the first data line may overlap the first light blocking member, and the second data line may overlap the second light blocking member.

The second light blocking member of one row of the pixels may be oriented substantially parallel to the second light blocking member of another row of the pixels.

The liquid crystal display may further include a common electrode disposed below the roof layer and facing the pixel electrode with the microcavity interposed therebetween.

The liquid crystal display may further include a lower insulating layer disposed between the common electrode and the roof layer.

The roof layer may include the partition wall part disposed between the first microcavity and the second microcavity.

As set forth above, according to an exemplary embodiment of the present invention, microcavities are formed so that each corresponds to more than one pixel, thereby making it possible to decrease the number of partition walls. Therefore, the aperture ratio of the liquid crystal display may be improved.

In addition, the microcavity structure in which the pixels are clustered is formed so as to be shifted by a pixel unit in each row or disposition of each pixel in one microcavity structure is formed so as to be shifted in each row, thereby making it possible to improve color uniformity.

### BRIEF DESCRIPTION OF THE DRAWINGS

FIG. 1 is a plan view showing a liquid crystal display according to an exemplary embodiment of the present invention.

FIG. 2 is a cross-sectional view taken along line II-II of FIG. 1.

FIG. 3 is a cross-sectional view taken along line of FIG. 1.

FIG. 4 is a schematic plan view showing structures of microcavities according to an exemplary embodiment of the present invention.

FIG. 5A is a cross-sectional view taken along line A-A of FIG. 4.

FIG. 5B is a cross-sectional view taken along line B-B of FIG. 4.

FIG. 5C is a cross-sectional view taken along line C-C of FIG. 4.

FIG. 6 is a schematic plan view showing structures of microcavities according to an exemplary embodiment of the present invention.

### DETAILED DESCRIPTION OF THE EMBODIMENTS

Exemplary embodiments of the present invention will be described in detail with reference to the accompanying drawings. However, the present invention is not limited to exemplary embodiments described therein, but may also be embodied in other forms. On the contrary, exemplary embodiments introduced herein are provided to make disclosed contents thorough and complete and sufficiently transfer the spirit of the present invention to those skilled in the art.

In the accompanying drawings, thickness of layers and regions may be exaggerated for clarity. The various Figures are thus not to scale. In addition, it will be understood that when a layer is referred to as being “on” another layer or substrate, the layer can be directly formed on another layer or substrate or the other layer may also be interposed therebetween. Like reference numerals designate like elements throughout the specification. All numerical values are approximate, and may vary.

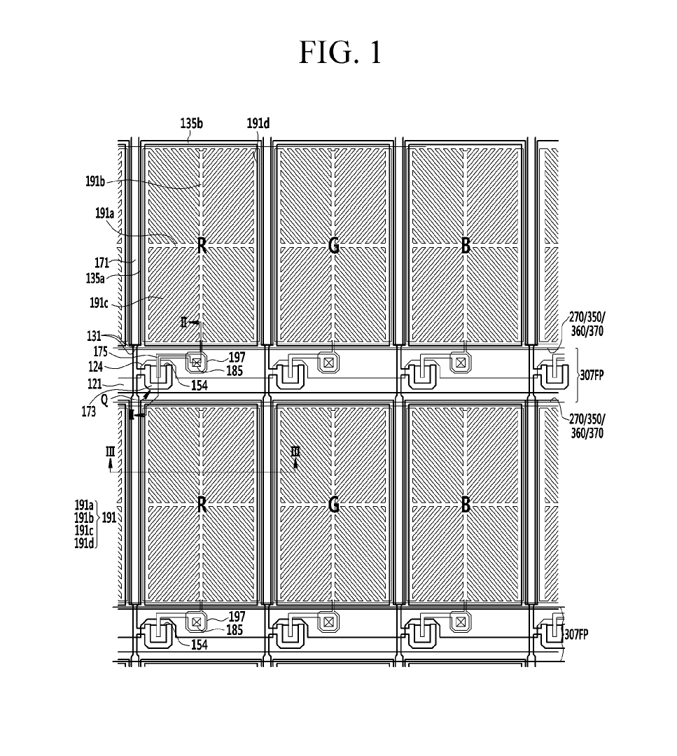

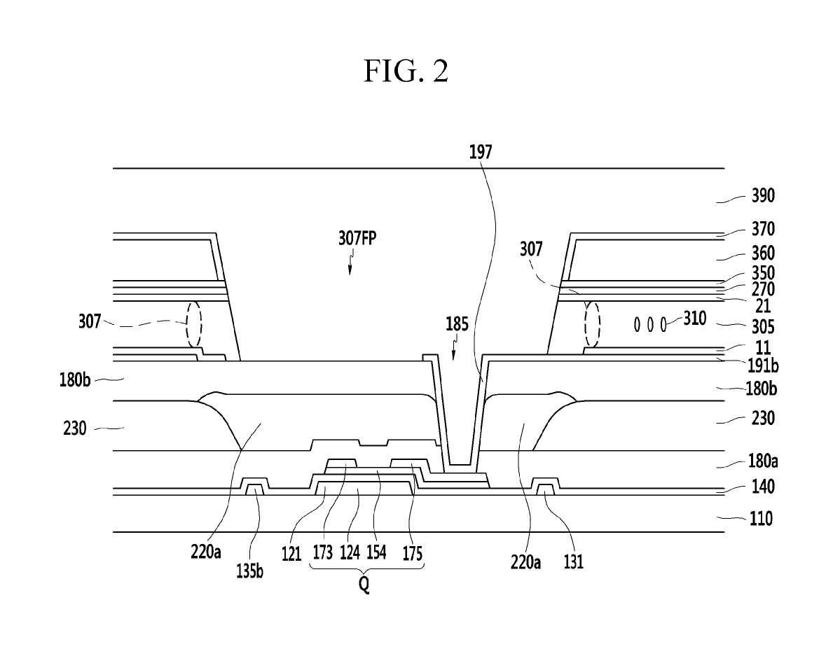

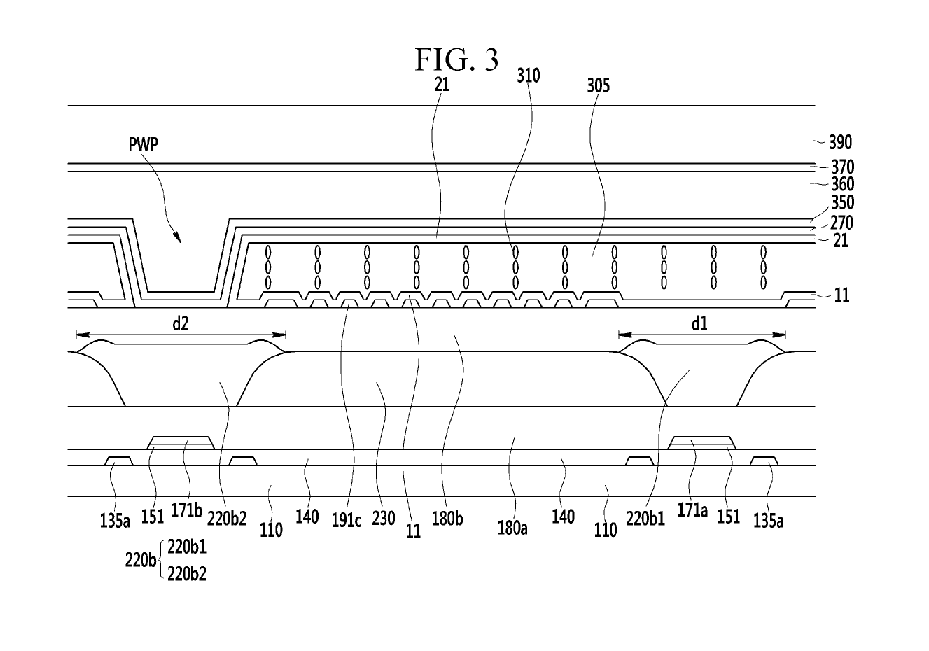

FIG. 1 is a plan view showing a liquid crystal display according to an exemplary embodiment of the present invention. FIG. 2 is a cross-sectional view taken along line II-II of FIG. 1. FIG. 3 is a cross-sectional view taken along line III-III of FIG. 1. FIG. 1 shows a 3*3 arrangement of pixels which are a portion of a larger pixel layout, and which correspond to a plurality of microcavities 305, respectively. In a liquid crystal display according to an exemplary embodiment of the present invention, these pixels may be repeatedly arranged in right and left directions and in top and bottom directions.

Referring to FIGS. 1 to 3, gate lines 121 and storage electrode lines 131 are formed on a substrate 110 formed of transparent glass, plastic, or the like. The gate lines 121 include gate electrodes 124. The storage electrode lines 131 are mainly extended in a horizontal direction and transfer a predetermined voltage such as a common voltage Vcom, or the like. The storage electrode line 131 includes a pair of vertical parts 135a extended substantially vertically with respect to the gate line 121 and a horizontal part 135b connecting ends of the pair of vertical parts 135a to each other. The vertical parts 135a and the horizontal part 135b of storage electrode line 131 have a structure in which they enclose a pixel electrode 191.

A gate insulating layer 140 is formed on the gate lines 121 and the storage electrode lines 131. A semiconductor layer disposed below data lines 171 and a semiconductor layer 154 disposed below source/drain electrodes and in a channel portion of a thin film transistor Q are formed on the gate insulating layer 140.

A plurality of ohmic contact members (not shown) may be formed on the respective semiconductor layers 151 and 154 and between the data lines 171 and the source/drain electrodes. In the present exemplary embodiment, the data line 171 includes a first data line 171a and a second data line 171b. The first data line 171a may overlap a first light blocking member 220b1 disposed between adjacent color filters 230, and the second data line 171b may overlap a second light blocking member 220b2 corresponding to a partition wall part PWP between adjacent microcavities 305.

Data conductors 171, 173, and 175 include a source electrode 173, the data line 171 connected to the source electrode 173, and a drain electrode 175, and are formed on the respective semiconductor layers 151 and 154 and the gate insulating layer 140.

The gate electrode 124, the source electrode 173, and the drain electrode 175 collectively form the thin film transistor Q together with the semiconductor layer 154, and a channel of the thin film transistor is formed in a portion of the semiconductor layer 154 between the source electrode 173 and the drain electrode 175.

A first interlayer insulating layer 180a is formed on the data conductors 171, 173, and 175 and the exposed portion of the semiconductor layer 154. The first interlayer insulating layer 180a may include an inorganic insulator or an organic insulator such as silicon nitride (SiNx), silicon oxide (SiOx), or the like.

The color filter 230 and light blocking members 220a and 220b are formed on the first interlayer insulating layer 180a.

First, the light blocking members 220a and 220b are configured in a lattice structure that has openings corresponding to regions in which an image is displayed, and are formed of a material that does not transmit light therethrough, i.e. is opaque. The color filters 230 are formed in the openings of the light blocking members 220a and 220b. The light blocking members 220a and 220b include a horizontal light blocking member 220a formed to extend along a direction that is substantially parallel with the gate line 121 and a vertical light blocking member 220b formed to extend along a direction that is substantially parallel with the data line 171.

Each color filter 230 may display any color, such as a primary color, e.g. a red, a green, or a blue. However, the color filter 230 is not limited to displaying red, green, or blue, but may also display one of a cyan, a magenta, a yellow, and a white, or any other desired color. The color filters 230 may be formed of materials displaying different colors for different pixels.

A second interlayer insulating layer 180b covering the color filters 230 and the light blocking members 220a and 220b is formed on the color filters 230 and the light blocking members 220a and 220b. The second interlayer insulating layer 180b may include an inorganic insulator or an organic insulator such as silicon nitride (SiNx), silicon oxide (SiOx), or the like.

In the case in which a step is generated due to a thickness difference between the color filters 230 and the light blocking members 220a and 220b, the second interlayer insulating layer 180b may be formed of an organic (or other) insulator to decrease or remove the step.

A contact hole 185 exposing the drain electrode 175 is formed in the color filter 230, the light blocking members 220a and 220b, and the interlayer insulating layer 180a and 180b.

The pixel electrode 191 is disposed on the second interlayer insulating layer 180b. The pixel electrode 191 may be formed of a transparent conductive material such as ITO, IZO, or the like.

The pixel electrode 191 generally has a rectangular shape, and includes a cross-shaped stem part including a horizontal stem part 191a and a vertical stem part 191b intersecting the horizontal stem part 191a. In addition, the pixel electrode 191 is divided into four sub-regions by the horizontal stem part 191a and the vertical stem part 191b, wherein each of the sub-regions includes a plurality of fine branch parts 191c each extending from one of the stem parts 191a, 191b. In addition, in the present exemplary embodiment, the pixel electrode 191 may further include outer side stem parts 191d connecting the fine branch parts 191c to each other at left and right outer sides thereof. In the present exemplary embodiment, the outer side stem parts 191d may be disposed at the left and right outer sides of the pixel electrode 191 or be disposed so as to be extended up to an upper portion or a lower portion of the pixel electrode 191.

The fine branch parts 191c of the pixel electrode 191 form an angle of approximately 40 to 45 degrees with respect to the gate line 121 or the horizontal stem part 191a. In addition, the fine branch parts 191c of two neighboring sub-regions may be orthogonal to each other. In addition, widths of the fine branch parts 191c may become gradually wider with distance from parts 191a/191b, or intervals between the fine stem parts 191c may be different from each other. Any arrangement, spacing, shapes, and configuration of fine branch parts 191c is contemplated.

The pixel electrode 191 includes an extension part 197 connected thereto at a lower end of the vertical stem part 191b and having an area wider than that of the vertical stem part 191b, is physically and electrically connected to the drain electrode 175 through the contact hole 185 at the extension part 197, and receives a data voltage applied from the drain electrode 175.

The above description of the thin film transistor Q and the pixel electrode 191 is illustrates one nonlimiting exemplary embodiment. Therefore, a structure of the thin film transistor and a design of the pixel electrode are not limited to the structures described in the present exemplary embodiment, but may be modified in any manner, for example in order to improve side visibility or for other reasons, as will be apparent to those of ordinary skill in the art.

A lower alignment layer 11, which may be a vertical alignment layer, is formed on the pixel electrode 191. The lower alignment layer 11, which is a liquid crystal alignment layer formed of, for example, polyamic acid, polysiloxane, polyimide, or the like, may include at least one of many generally used materials.

An upper alignment layer 21 is disposed at a portion facing the lower alignment layer 11, and the microcavity 305 is formed between the lower alignment layer 11 and the upper alignment layer 21. Liquid crystal materials 310 including liquid crystal molecules are injected into the microcavity 305, and the microcavity 305 has an inlet 307. A plurality of microcavities 305 may be formed in a column direction of the pixel electrode 191, in other words, in a vertical direction in the view of FIG. 1. In the present exemplary embodiment, the liquid crystal materials 310 including alignment materials forming the alignment layers 11 and 21 and the liquid crystal molecules may be injected into the microcavities 305 using capillary force. In the present exemplary embodiment, the lower alignment layer 11 and the upper alignment layer 21 are only distinguished from each other depending on their positions, and may be connected to each other, as shown in FIG. 3. The lower alignment layer 11 and the upper alignment layer 21 may be simultaneously formed.

The microcavity 305 is divided in the vertical direction by a plurality of trenches 307FP disposed at portions overlapping the gate line 121, such that a plurality of microcavities 305 are formed. Here, the plurality of microcavities 305 may be formed with their longer sides extending in the column direction of the pixel electrode 191, in other words, the vertical direction. In addition, the microcavities 305 are divided in the horizontal direction by partition wall parts PWP to be described below, such that a plurality of microcavities 305 are formed. Here, the plurality of microcavities 305 may be formed so that successive microcavities 305 extend in a row direction of the pixel electrode 191, in other words, in the horizontal direction in which the gate line 121 extends. In the present exemplary embodiment, each of the microcavities 305 may correspond to two or more pixels, where each pixel may be a region that may be defined by the gate line 121 and the data line 171, but is not necessarily limited thereto. The pixels may correspond to points of contrast of minimum units configuring a screen. In the present exemplary embodiment, one microcavity 305 may correspond to a red color filter, a green color filter, and a blue color filter each corresponding to a red pixel R, a green pixel G, and a blue pixel B.

A common electrode 270 and a lower insulating layer 350 are disposed on the upper alignment layer 21. The common electrode 270 receives a common voltage applied thereto and generates an electric field together with the pixel electrode 191 to which the data voltage is applied, so as to determine a direction in which the liquid crystal materials 310 disposed in the microcavity 305 are inclined. The common electrode 270 forms a capacitor together with the pixel electrode 191 to maintain the applied voltage even after the thin film transistor is turned off. The lower insulting layer 350 may be formed of, for example, silicon nitride (SiNx) or silicon oxide SiO2.

Although the case in which the common electrode 270 is formed above the microcavity 305 has been described in the present exemplary embodiment, the common electrode 270 may alternatively be formed below the microcavity 305 to drive a liquid crystal in a horizontal electric field mode, in another exemplary embodiment.

A roof layer 360 is disposed on the lower insulating layer 305. The roof layer 360 serves as a support so that the microcavity 305, which is a cavity between the pixel electrode 191 and the common electrode 270, may maintain its shape without collapsing or being crushed. The roof layer 360 may include a photo-resist or other organic materials.

An upper insulating layer 370 is disposed on the roof layer 360. The upper insulating layer 370 may contact an upper surface of the roof layer 360. The upper insulting layer 370 may be formed of, for example, silicon nitride (SiNx) or silicon oxide SiO2.

As shown in FIG. 2, the upper insulating layer 370 may cover a side surface of the roof layer 360. In a modified exemplary embodiment, the upper insulating layer 370 may be formed so that side walls of the lower insulating layer 350, the roof layer 360, and the upper insulating layer 370 are substantially aligned with each other, or coplanar.

A capping layer 390 is disposed on the upper insulating layer 370. The capping layer 390 includes, for example, an organic material or an inorganic material. In the present exemplary embodiment, the capping layer 390 may be disposed in the trench 307FP as well as on the upper insulating layer 370. Here, the capping layer 390 may cover the inlet 307 of the microcavity 305 exposed by the trench 307FP. Although the case in which the liquid crystal materials are removed from the trench 307TF has been shown in the present exemplary embodiment, the liquid crystal materials remaining after being injected into the microcavity 305 may also remain in the trench 307FP.

In the present exemplary embodiment, as shown in FIG. 3, the partition wall part PWP is formed between microcavities 305 that are adjacent to each other in the horizontal direction. The partition wall part PWP may be formed to extend along a direction in which the data lines 171 are extended and may be covered by the roof layer 360. The partition wall part PWP is filled with the common electrode 270, the lower insulating layer 350, the roof layer 360, and the upper insulating layer 370. These structures may collectively form a partition wall to partition or define the microcavity 305. In the present exemplary embodiment, since a partition wall structure such as the partition wall part PWP is present in the microcavities 305, even though the substrate 110 is bent, microcavities 305 and other components are protected from induced stresses or other damage.

In the present exemplary embodiment, a partition wall part PWP may be formed every three pixels in the horizontal direction. Therefore, each microcavity 305 may correspond to three pixels. For example, one microcavity 305 may cover or extend across a plurality of pixels that includes a red pixel R, a green pixel G, and a blue pixel B. In the present exemplary embodiment, the red pixel R, the green pixel G, and the blue pixel B may configure a unit pixel, which may be repeatedly arranged in right and left (e.g. horizontal) directions and in top and bottom (e.g. vertical) directions. That is, the unit pixel may correspond to one microcavity. Here, the partition wall part PWP may be formed between the red pixel R and the blue pixel B adjacent to each other. Embodiments of the invention contemplate any number, placement, and arrangement of partition wall parts PWP.

In the present exemplary embodiment, the vertical light blocking member 220b includes the first light blocking member 220b1 and the second light blocking member 220b2. The first light blocking member 220b1 is disposed between the pixels corresponding to each microcavity 305, and the second light blocking member 220b2 is disposed to cover the gap between adjacent microcavities 305 neighboring to each other. Since the partition wall part PWP is formed between the microcavities 305 (in this embodiment, the gap between every grouping of three pixels), the partition wall part PWP may overlap the second light blocking member 220b2.

In the present exemplary embodiment, a first width d1 of the first light blocking member 220b1 is different from a second width d2 of the second light blocking member 220b2. The second light blocking member 220b2 is formed in a width wider than that of the first light blocking member 220b1 in order to prevent leakage of light generated due to the partition wall part PWP. When a region occupied by the microcavity is increased so as to correspond to two or more pixels as in the present exemplary embodiment, some of the partition wall parts PWPs formed per pixel in the related art may be removed. Therefore, an aperture ratio may be improved.

Although not shown, a polarizer may be formed on outer surfaces of the substrate 110 and the capping layer 390.

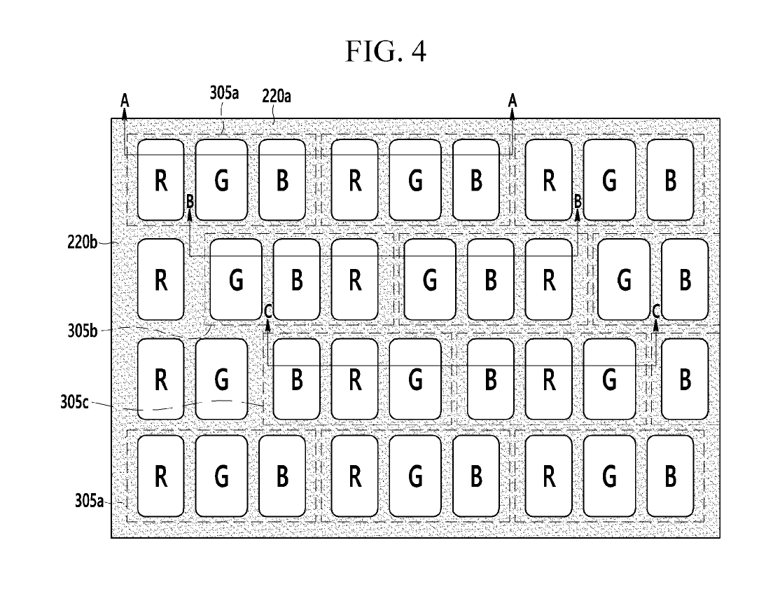

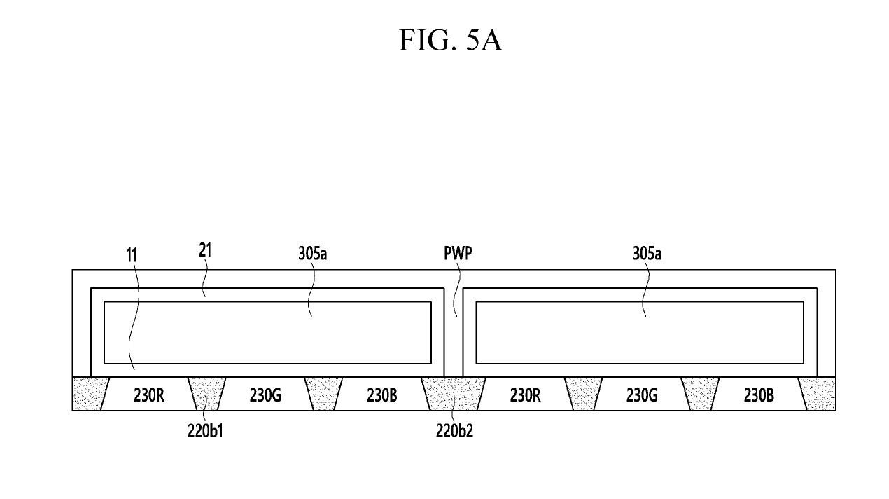

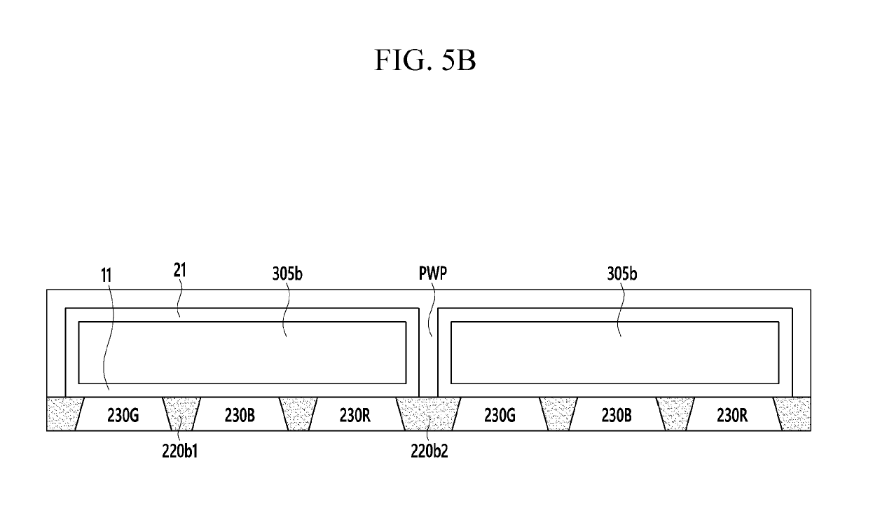

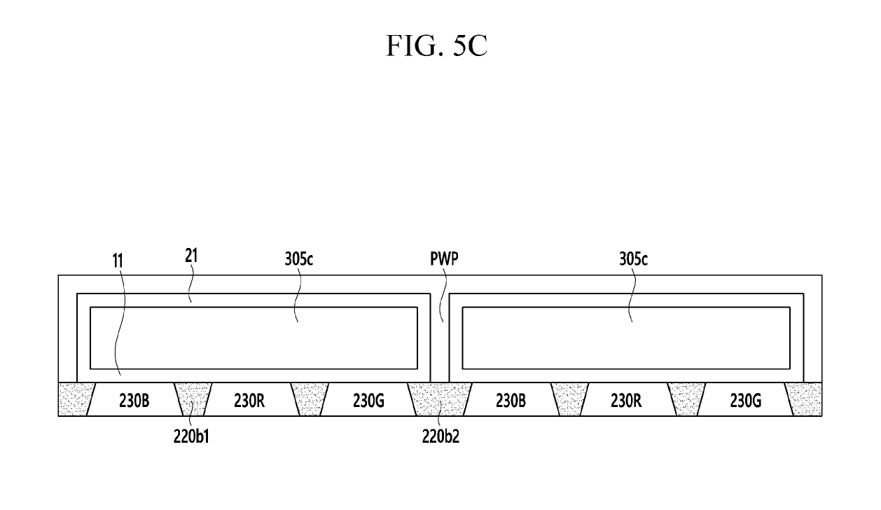

FIG. 4 is a schematic plan view showing structures of microcavities according to an exemplary embodiment of the present invention. FIG. 5A is a cross-sectional view taken along line A-A of FIG. 4. FIG. 5B is a cross-sectional view taken along line B-B of FIG. 4. FIG. 5C is a cross-sectional view taken along line C-C of FIG. 4.

Referring to FIG. 4, a liquid crystal display according to the present exemplary embodiment includes horizontal light blocking members 220a formed in the direction in which the gate lines are extended and vertical light blocking members 220b intersecting the horizontal light blocking members 220a and formed in the direction in which the data lines are extended. The plurality of pixels are arranged generally as a matrix in regular rows and columns, and a red pixel R, green pixel G, and blue pixel B are grouped together and this grouping disposed between each vertical light blocking member 220b. When two rows neighboring each other in the vertical direction in the matrix are first and second rows, respectively, the red pixel R, the green pixel G, and the blue pixel B are sequentially arranged repeatedly in the first and second rows. In the present exemplary embodiment, one microcavity 305 may correspond to three pixels. Here, a sequence of the red pixel R, the green pixel G, and the blue pixel B arranged to correspond to one microcavity disposed in the first row may be different from that of pixels arranged to correspond to one microcavity and disposed in the second row.

In the configuration of FIG. 4, the first pixel row has the pixels corresponding to each microcavity 305a arranged in the order RGB. In the second pixel row, the pixels of each microcavity 305b are instead arranged in the order GBR, while in the third row, each microcavity 305c has pixels arranged in the order BRG. This pattern repeats for successive pixel rows.

In the present exemplary embodiment, the pixels are arranged in regular or linear columns, while a first microcavity 305a disposed in the first row, a second microcavity 305b disposed in the second row, and a third microcavity 305 disposed in the third row are disposed so as to be misaligned with each other. In detail, the first microcavity 305a and the second microcavity 305b are disposed so as to be misaligned with each other by one pixel interval/width, and the second microcavity 305b and the third microcavity 305c are also disposed so as to be misaligned with each other by one pixel interval/width. Disposition of the microcavities and disposition of the pixels therein may be repeated every three rows.

Referring to FIGS. 4 and 5A, the first microcavity 305a in the first row corresponds to, in order, a red color filter 230R, a green color filter 230G, and a blue color filter 230B, and alignment layers 11 and 21 are formed on an inner wall of the first microcavity 305a as above. A width of the first light blocking members 220b1 disposed between the red color filter 230R and the green color filter 230G and between the green color filter 230G and the blue color filter 230B is smaller than that of the second light blocking member 220b2 corresponding to the partition wall part PWP between two adjacent first microcavities 305a. The first light blocking members 220b1 are disposed in right and left of the green color filter 230G. Therefore, in the first row, transmittance of the green pixel G corresponding to the green color filter 230G disposed relatively far from the partition wall part PWP may be perceived to be greater.

Referring to FIGS. 4 and 5B, the second microcavity 305b in the second row corresponds to, in order, a green color filter 230G, a blue color filter 230B, and a red color filter 230R, and alignment layers 11 and 21 are formed on an inner wall of the second microcavity 305b as above. A width of the first light blocking members 220b1 disposed between the green color filter 230G and the blue color filter 230B and between the blue color filter 230B and the red color filter 230R is smaller than that of the second light blocking member 220b2 corresponding to the partition wall part PWP between two adjacent second microcavities 305b. The first light blocking members 220b1 are disposed in right and left of the blue color filter 230B. Therefore, in the second row, transmittance of the blue pixel B corresponding to the blue color filter 230B disposed relatively far from the partition wall part PWP may be perceived to be greater.

Referring to FIGS. 4 and 5C, the third microcavity 305c in the third row corresponds to, in order, a blue color filter 230B, a red color filter 230R, and a green color filter 230G, and alignment layers 11 and 21 are formed on an inner wall of the third microcavity 305c as above. A width of the first light blocking members 220b1 disposed between the blue color filter 230B and the red color filter 230R and between the red color filter 230R and the green color filter 230G is smaller than that of the second light blocking member 220b2 corresponding to the partition wall part PWP between two adjacent microcavities 305c. The first light blocking members 220b1 are disposed in right and left of the red color filter 230R. Therefore, in the third row, transmittance of the red pixel R corresponding to the red color filter 230R disposed relatively far from the partition wall part PWP may be perceived to be greater.

As described above, in the liquid crystal display according to the present exemplary embodiment, three pixels are clustered in one row to form one microcavity 305, thereby making it possible to decrease the number of partition wall parts PWPs and thus decreasing an aspect ratio. In addition, the microcavity 305 is shifted by one pixel interval in each row, such that relative perceived transmittance of the green pixel G, the blue pixel B, and the red pixel R is increased in respective rows. Therefore, the liquid crystal display may generally maintain substantially uniform color characteristics across the entire display.

As described above with reference to FIGS. 1 and 3, the first light blocking member 220b1 and the second light blocking member 220b2 included in the vertical light blocking member 220b may overlap the first data line 171a and the second data line 171b, respectively. In the present exemplary embodiment, in one vertical light blocking member 220b, the second light blocking member 220b2 of the first row, the first light blocking member 220b1 of the second row, and the first light blocking member 220b1 of the third row may be sequentially arranged repeatedly. In other words, the second light blocking member 220b2 disposed in the first row, the second light blocking member 220b2 disposed in the second row, and the second light blocking member 220b2 in the third row may be disposed so as to be misaligned with each other. That is, in certain embodiments, both the pixels in each column and thus their light blocking members may be misaligned or offset, so that pixel columns and their light blocking members are not strictly aligned. Pixels and/or their light blocking members may be offset from each other by any amount.

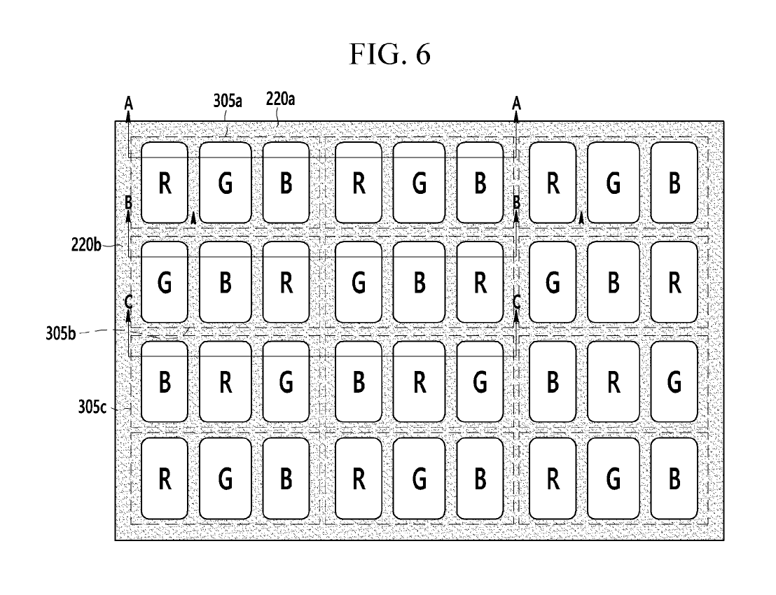

FIG. 6 is a schematic plan view showing structures of microcavities according to an exemplary embodiment of the present invention.

Referring to FIG. 6, a liquid crystal display according to the present exemplary embodiment includes horizontal light blocking member 220b formed generally in the direction in which the gate lines are extended, and vertical light blocking member 220b intersecting the horizontal light blocking member 220a and formed generally in the direction in which the data lines are extended. The plurality of pixels are arranged in matrix form, and the red pixel R, the green pixel G, and the blue pixel B are disposed between the vertical light blocking members 220b. Pixel rows may contain repeating groups of different-color pixels, where the groups and their individual arrangements of pixels may vary in any manner. In the present exemplary embodiment, one microcavity 305 may correspond to three pixels. Here, a sequence of the red pixel R, the green pixel G, and the blue pixel B arranged in one microcavity disposed in the first row may be different from that of pixels arranged in one microcavity disposed in the second row.

When it is assumed that a first row in the matrix shown in FIG. 6 is a first row, a second row in the matrix is a second row, and a third row in the matrix is a third row, the red pixel R, the green pixel G, and the blue pixel B are sequentially arranged in one microcavity 305a disposed in the first row; the green pixel G, the blue pixel B, and the red pixel R are sequentially arranged in one microcavity 305b disposed in the second row; and the blue pixel B, the red pixel R, and the green pixel G are sequentially arranged in one microcavity 305c disposed in the third row.

In the present exemplary embodiment, different pixels are arranged in the same columns of the matrix, and the first microcavity 305a disposed in the first row, the second microcavity 305b disposed in the second row, and the third microcavity 305c disposed in the third row are disposed so as to be in parallel with each other. Disposition of the microcavity and disposition of the pixel in each row may be repeated every three rows, or in any other manner as desired.

Cross-sectional views taken along line A-A, lie B-B, and line C-C of FIG. 6 may be the same as FIG. 5A, FIG. 5B, and FIG. 5C, respectively.

Referring to FIGS. 6 and 5A, the first microcavity 305a in the first row corresponds to, in order, a red color filter 230R, a green color filter 230G, and a blue color filter 230B, and alignment layers 11 and 21 are formed on an inner wall of the first microcavity 305a, as above. A width of the first light blocking members 220b1 disposed between the red color filter 230R and the green color filter 230G and between the green color filter 230G and the blue color filter 230B is smaller than that of the second light blocking member 220b2 corresponding to the partition wall part PWP between two adjacent first microcavities 305a. The first light blocking members 220b1 are disposed in right and left of the green color filter 230G. Therefore, in the first row, transmittance of the green pixel G corresponding to the green color filter 230G disposed relatively far from the partition wall part PWP may be perceived to be greater.

Referring to FIGS. 6 and 5B, the second microcavity 305b in the second row corresponds to, in order, a green color filter 230G, a blue color filter 230B, and a red color filter 230R, and alignment layers 11 and 21 are formed on an inner wall of the second microcavity 305b, as above. A width of the first light blocking members 220b1 disposed between the green color filter 230G and the blue color filter 230B and between the blue color filter 230B and the red color filter 230R is smaller than that of the second light blocking member 220b2 corresponding to the partition wall part PWP between two adjacent second microcavities 305b. The first light blocking members 220b1 are disposed in right and left of the blue color filter 230B. Therefore, in the second row, transmittance of the blue pixel B corresponding to the blue color filter 230B disposed relatively far from the partition wall part PWP may be perceived to be greater.

Referring to FIGS. 6 and 5C, the third microcavity 305c in the third row corresponds to, in order, a blue color filter 230B, a red color filter 230R, and a green color filter 230G, and alignment layers 11 and 21 are formed on an inner wall of the third microcavity 305c as above. A width of the first light blocking members 220b1 disposed between the blue color filter 230B and the red color filter 230R and between the red color filter 230R and the green color filter 230G is smaller than that of the second light blocking member 220b2 corresponding to the partition wall part PWP between two adjacent microcavities 305c. The first light blocking members 220b1 are disposed in right and left of the red color filter 230R. Therefore, in the third row, transmittance of the red pixel R corresponding to the red color filter 230R disposed relatively far from the partition wall part PWP may be perceived to be greater.

As described above, in the liquid crystal display according to the present exemplary embodiment, three pixels are clustered in one row to form one microcavity 305, thereby making it possible to decrease the number of partition wall parts PWPs and thus decreasing an aspect ratio. In addition, the respective pixels in one microcavity structure are disposed so as to be shifted for each row, such that relative perceived transmittance of the green pixel G, the blue pixel B, and the red pixel R is increased in respective rows. Therefore, the liquid crystal display may generally maintain substantially uniform color characteristics across the entire display.

As described above with reference to FIGS. 1 and 3, the first light blocking member 220b1 and the second light blocking member 220b2 included in the vertical light blocking member 220b may overlap the first data line 171a and the second data line 171b, respectively. In the present exemplary embodiment, one vertical light blocking member 220b may be the first light blocking member 220b1 or the second light blocking member 220b2. In other words, the second light blocking member 220b2 disposed in the first row, the second light blocking member 220b2 disposed in the second row, and the second light blocking member 220b2 in the third row may be disposed so as to be in parallel with each other. That is, in certain embodiments, the pixels of each pixel column may align with each other to form straight or linear columns.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

<Description of symbols>

| | | | |
|---|---|---|---|
| 305 | microcavity | | |
| 307 | inlet | 307FP | trench |
| 350 | lower insulating layer | 360 | roof layer |
| 370 | upper insulating layer | 390 | capping layer |

What is claimed is:

1. A liquid crystal display comprising:
a substrate including a plurality of pixels;
a pixel electrode disposed in each of the pixels;
a roof layer facing the pixel electrode;
a liquid crystal layer disposed in a plurality of microcavities between the pixel electrodes and the roof layer, each of the microcavities including liquid crystal material therein,
wherein each of the microcavities extends across at least two of the pixels, and
wherein a width of a first light blocking member positioned between adjacent ones of the pixels corresponding to one microcavity is different from a width of a second light blocking member positioned between adjacent pixels of adjacent microcavities.

2. The liquid crystal display of claim 1, wherein:
each microcavity extends across three of the pixels so as to form a pixel group, and
the liquid crystal display further includes a repeated arrangement of the pixel groups.

3. The liquid crystal display of claim 2, further comprising:
a partition wall part is disposed between adjacent microcavities.

4. The liquid crystal display of claim 3, wherein:
each pixel group includes a red pixel, a green pixel, and a blue pixel.

5. The liquid crystal display of claim 4, wherein:
the pixels are arranged in a matrix configuration,
the matrix configuration includes adjacent first and second rows, and
the pixel groups of the first row have an order of pixel colors that is different from that of the pixel groups of the second row.

6. The liquid crystal display of claim 5, further comprising:
a color filter disposed on the substrate, wherein the color filter includes a red color filter, a green color filter, and a blue color filter respectively corresponding to the red pixels, the green pixels, and the blue pixels, and
the first light blocking member is disposed between adjacent ones of the color filters corresponding to the pixels of one microcavity, and the second light blocking member is disposed between color filters corresponding to the pixels of adjacent ones of the microcavities.

7. The liquid crystal display of claim 6, wherein:
the partition wall part overlaps the second light blocking member.

8. The liquid crystal display of claim 3, wherein:
the pixels and their corresponding microcavities are arranged in a matrix configuration having rows of the pixels and rows of the microcavities, and further having columns of the pixels and columns of the microcavities, and
the microcavities of each column of the microcavities are offset from one another.

9. The liquid crystal display of claim 8, wherein:
each column of the pixels has pixels of a single color.

10. The liquid crystal display of claim 9, further comprising a data line,
wherein the data line includes a first data line positioned between two pixels of one microcavity, and a second data line positioned between adjacent microcavities, and
wherein the first data line overlaps the first light blocking member, and the second data line overlaps the second light blocking member.

11. The liquid crystal display of claim 10, wherein:
microcavities of one column of the microcavities are offset from each other by one pixel width.

12. The liquid crystal display of claim 11, wherein:
the second light blocking member of one row of the pixels is offset from the second light blocking member of another row of the pixels.

13. The liquid crystal display of claim 12, wherein:
an order of colors of the pixels of the microcavities of one row of the pixels is repeated every three rows of the pixels.

14. The liquid crystal display of claim 3, wherein:
the pixels and their corresponding microcavities are arranged in a matrix configuration having rows of the pixels and rows of the microcavities and further having columns of the pixels and columns of the microcavities, and
the microcavities of each column of the microcavities are substantially collinear.

15. The liquid crystal display of claim 14, wherein:
different columns of the pixels have pixels of different colors.

16. The liquid crystal display of claim 15, wherein:
a data line,
wherein the data line includes a first data line positioned between two pixels of one microcavity, and a second data line positioned between adjacent microcavities, and
wherein the first data line overlaps the first light blocking member, and the second data line overlaps the second light blocking member.

17. The liquid crystal display of claim 16, wherein:
the second light blocking member of one row of the pixels is oriented substantially parallel to the second light blocking member of another row of the pixels.

18. The liquid crystal display of claim 14, further comprising:
a common electrode disposed below the roof layer and facing the pixel electrode with the microcavity interposed therebetween.

19. The liquid crystal display of claim 18, further comprising:
a lower insulating layer disposed between the common electrode and the roof layer.

20. The liquid crystal display of claim 19, wherein:
the roof layer includes the partition wall part disposed between the first microcavity and the second microcavity.
